(19) United States
(12) Patent Application Publication
(10) Pub. No.: US 2024/0291350 A1
(43) Pub. Date: Aug. 29, 2024

(54) HOLDING DEVICE AND HOLDING SYSTEM

(71) Applicant: Bühler Motor GmbH, Nürnberg (DE)

(72) Inventors: Kai Bretschneider, Nürnberg (DE); Gerhard Hofmann, Großhabersdorf (DE); Mohammad Wahhoud, Nürnberg (DE)

(73) Assignee: Bühler Motor GmbH, Nürnberg (DE)

(21) Appl. No.: 18/581,940

(22) Filed: Feb. 20, 2024

(30) Foreign Application Priority Data
Feb. 24, 2023 (DE) 10 2023 104 617.9
Jan. 22, 2024 (DE) 10 2024 101 758.9

(51) Int. Cl. H02K 7/106; H02K 49/10

(52) U.S. Cl. CPC H02K 7/106; H02K 49/106

(57) ABSTRACT

A holding device comprising a soft iron element and a magnet, which are arranged concentrically to one another, wherein the magnet, in operative connection with the soft iron element, exerts a holding torque on a shaft in a static state, wherein the magnet is arranged on the shaft, on the inner circumference of the soft iron element (UE), and forms a second rotating component (K2), and the holding device is in connection with one of the end shield of an electric drive and wherein the soft iron element is arranged on the shaft, on the inner circumference (UM) of the magnet, and forms a first rotating component (K1), and wherein the holding device is in connection with one of the end shield of an electric drive.

### CROSS-REFERENCE TO RELATED APPLICATIONS

The present patent application claims priority from German Application No. DE 10 2024 101 758.9, filed Jan. 22, 2024, and German Patent Application No. DE 10 2023 104 617.9, filed Feb. 24, 2023, both of which are incorporated herein by reference in their entireties.

### BACKGROUND OF THE INVENTION

### Field of the Invention

The invention relates to a holding device having a soft iron element and a magnet which are arranged to exert a holding torque and a holding system.

### Description of Related Art Including Information Disclosure Under 37 CFR 1.97 and 1.98

Electric drives such as electric motors with integrated or attached devices for directly influencing the movement of a rotating drive shaft of the electric motors are known from the prior art, for example to decelerate the applications attached to them (such as an electrically operated roller blind) or to hold them in a determined position. At the same time, it is desirable and also known to “lock” the shaft in this position, i.e. to hold it in position for as long as desired. This requires a holding torque to be exerted on the shaft by the device or the electric motor during this static state. The associated holding torque (i.e. the torque that keeps the shaft or the electromotive drive at a standstill without the shaft being able to continue rotating) must first be overcome by the device or the force of the electric motor before the shaft can rotate again or switch to dynamic operation (for example, to fully close or open an electrically operated roller blind).

It is known to exert the holding torque on the shaft by means of an electromagnetically functioning holding device in which the braking force is generated via the targeted electrification of an electric coil (or non-electrification). This type of holding device can be attached separately to the electric motor and form a holding system with it or be built into the electric motor itself. In addition to the costly, complex and complicated construction of such holding devices, the disadvantage is (a possible) high accompanying noise level during operation, which can be unpleasant for users. The use of an attached electromagnetic brake, driven by self-locking, by spring force or generally a cogging torque-increasing motor design is also known. It is further known to increase the holding torque by making adjustments in a mounted gearbox part of the electric motor (for example, a worm gearbox is provided for this purpose). In most known cases, such measures lead to poorer efficiency and higher component wear.

Another problem is that in the event of a power supply failure (power failure, empty battery or similar), an electrically operated holding device can no longer lock the shaft in a desired position and thus the application connected to the shaft (e.g. a roller blind) moves out of position without resistance and without braking, which poses a potential risk of accidents. It is therefore important to apply the necessary holding torque to the shaft in a permanent, stable and uninterrupted manner. A holding torque that an electric motor itself can provide is usually not sufficient if the weight of the connected load (such as a roller blind or rolling gate) is too high, which is why it is necessary to provide an increased holding torque on the shaft in another manner.

The carefully considered design of such holding devices is also important when used for tubular motors, for example for electrically operated roller blinds, where the tubular design of the motor and attachment parts means that the available space extends axially and must therefore be compact.

### BRIEF SUMMARY OF THE INVENTION

The object of the present invention is therefore to propose a holding device which overcomes the aforementioned disadvantages of the prior art and, in particular, can provide a significantly increased holding torque on the shaft in a stable and reliable manner in the static state of the shaft, with a simple design of the holding device. Furthermore, a holding system is proposed which comprises a holding device according to the invention in operative connection with an electric drive. The performance data of an electric drive should be affected as little as possible during dynamic operation and noise levels should be kept to a minimum.

This object is achieved by a holding device comprising a soft iron element and a magnet, which are arranged concentrically to one another, wherein the magnet in operative connection with the soft iron element exerts a holding torque on a shaft in a static state, wherein the magnet is arranged on the shaft, on the inner circumference of the soft iron element (UE), and forms a second rotating component (K2), and wherein the holding device is in connection with one of the two end shields of an electric drive. The end shields can be the A-side (drive side) end shield or the B-side (opposite the drive side, output side) end shield. Alternatively, an adapter plate can be provided instead of the A-side or B-side end shield.

This object is alternatively achieved by a holding device comprising a soft iron element and a magnet, which are arranged concentrically to one another, wherein the magnet in operative connection with the soft iron element exerts a holding torque on a shaft in a static state, wherein the soft iron element is arranged on the shaft, on the inner circumference (UM) of the magnet, and forms a first rotating component (K1) and wherein the holding device is in connection with one of the two end shields of an electric drive. The end shields can be the A-side (drive side) end shield or the B-side (opposite the drive side, output side) end shield. Alternatively, an adapter plate can be provided instead of the A-side or B-side end shield.

Advantageously, a significantly increased holding torque can be applied by the holding device according to the invention in order to hold the shaft in position by the exerted holding torque. For example, this can be used to hold a roller blind in position if, approximately, the space is only to be partially darkened by it after it has been decelerated. The holding force for the holding torque is generated by the interaction of the magnet with the soft iron element on the basis of an acting reluctance force. The concentric (or coaxial) arrangement of the soft iron element and magnet, which is connected to an application such as approximately a roller blind, means that the components of the holding device can be dimensioned as required. The provision of a holding torque (approximately by a larger magnet) can be adjusted. A simple design with few components is advantageous. It is particularly preferred that only a single, contiguous magnet is arranged concentrically with the soft iron material.

The magnet is made of a known permanent magnetic material, for example a neodymium-iron-boron material. Other examples of permanent magnets are well known to the person skilled in the art.

The static state is defined by the time during which the torque of the shaft is not overcome. In contrast, the dynamic state is defined by the fact that the shaft moves (for example due to an externally applied drive force) and overcomes the applied holding torque.

In one embodiment, the holding device, alternatively by means of a separately attached brake or approximately by an attached electric drive that can itself act as a brake, can also initiate the deceleration of the connected application. The magnetic interaction between the soft iron element and the magnet ensures the holding force on the shaft and thus the increased holding torque, so that the shaft remains in one position. The holding device according to the invention does not require a separate power supply, i.e. it is not energized. The advantageous torque variance of the holding device can be used to improve the vibration behavior of the overall drive during operation of the roller blind.

In one embodiment, the holding device comprises a soft iron element and a magnet, which are arranged concentrically to one another, wherein the magnet exerts a holding torque on a shaft in operative connection with the soft iron element in a static state, wherein the magnet is arranged on the shaft, on the inner circumference (or along it, or inside it) of the soft iron element, and forms a second rotating component, and wherein the holding device is in connection with one of the two desired end shields of an electric drive. Here, the magnet is (fixed, static) arranged on the shaft and can rotate together with the shaft. The soft iron element remains rigidly fastened in position. A predefined distance in the form of an air gap is provided between the second rotating component or the magnet and the surrounding soft iron element. In other words, the magnet is arranged as a second rotating component on the shaft in such a way that it can rotate together with the shaft during the dynamic state. The switch element is also in a fixed position during the dynamic state. In the static state, i.e. when the second rotating component is stationary, the interaction between the magnet and the soft iron element causes a holding torque to be exerted on the shaft. During this time, the second rotating component remains immobile in a static state. The shaft can no longer rotate due to the holding torque exerted by the magnetic force and remains in position. Advantageously, this makes it possible to hold an apparatus attached to the device, such as a roller blind, in one position, but also to stop it. It is possible that the soft iron element as a component accommodates, encloses or surrounds the magnet in whole or in part. This enables a compact, efficient design of the device.

In an alternative embodiment, the holding device comprises a soft iron element and a magnet, which are arranged concentrically to one another, wherein the magnet in operative connection with the soft iron element exerts a holding torque on a shaft in a static state, wherein the soft iron element is arranged on the shaft, on the inner circumference (or along, or inside) the magnet, and forms a first rotating component, and wherein the holding device is in connection with one of the two desired end shields of an electric drive. Here, the soft iron element (fixed, static) is arranged on the shaft and can rotate together with the shaft. The magnet remains rigidly fastened in position. A predefined distance in the form of an air gap is provided between the first rotating component or the soft iron element and the surrounding magnet. In other words, the soft iron element is arranged as the first rotating component on the shaft in such a manner that it can rotate together with the shaft during the dynamic state. The solenoid is also in a fixed position during the dynamic state. In the static state, i.e. when the first rotating component is stationary, the interaction between the magnet and the soft iron element causes a holding torque to be exerted on the shaft. During this time, the first rotating component remains immobile in a static state. The shaft can no longer rotate due to the holding torque exerted by the magnetic force and remains in position. Advantageously, this makes it possible to hold an apparatus attached to the device, such as a roller blind, in one position, but possibly also to stop it. It may be provided that the magnet as a component completely or partially accommodates, encloses or surrounds the soft iron element. This enables a compact, efficient design of the device.

One of the two desired end shields can comprise a magnet and the soft iron element. The end shields can be made of plastic or a suitable material known to the person skilled in the art and contain a magnet or soft iron element. For example, the end shields offer protection against corrosion caused by penetrating moisture or contamination. Also, in accordance with the previous alternative arrangements, the magnet or soft iron element may be fastened or arranged within one of the two end shields such that it remains statically fixed in position while the first or second rotating component is movably mounted on the shaft.

In a further development, the holding device is in operative connection with a pinion fastened to the shaft and is encompassed by the end shield. Here, the end shield is the A-side end shield on the drive side. The pinion is also located on the drive side. The A-side end shield is designed as an integral end shield. The electrical connections or contacts of the electric drive are located on the side opposite the drive side (output side, B-side end shield) of the electric drive.

In an advantageous embodiment of the invention, the soft iron element has a plurality of pole teeth in its inner circumference or on its outer circumference.

Furthermore, the plurality of pole teeth of the soft iron element are advantageously matched relative to the number of poles of the at least one magnet.

A suitable adjustment of the arrangement of the number of magnetic poles and the number of teeth of the soft iron element component results in an improvement of the vibration behavior during operation and the noise development. The number of teeth can vary and be adjustable.

It is preferable that the pole teeth are arranged at the same angle α to each other and/or have a pole tooth contour. The angle α can, for example, be designed in such a way that (depending on the number of poles of the magnet, for example) the pole teeth are provided at an angle α of preferably 45° to 60°. Apart from this, all angles α in the area of 1° to 90° are conceivable. The contour of the pole teeth can, for example, be designed to be round-oval, triangular, square or hexagonal and thus remain adaptable to the magnet. The contour is influenced by the variance in the width of the pole teeth. A small tooth width can have an influence on the position-dependent magnetic resistance within a detent period. This can positively influence and increase the holding torque.

It is also preferable for the pole teeth to have bevels on their outer circumference. This has the advantage of an improved detent torque. The chamfers can be located on the radial or axial edges of the pole teeth and have parallel or converging edges.

It is possible that the holding torque is set via the axial length and/or the material selection and/or via an air gap and/or an axial overlap of the rotating component (K1, K2). The advantage of these measures is that any power losses caused by the holding device are minimized in the dynamic state. The holding torque can be adapted to the application.

Furthermore, a shaft receptacle can be provided in the inner circumference of the (first or second) rotating component, which receives the shaft and secures it (radially). The shaft receptacle can be a separate component (for example, a sleeve or bushing) that is inserted into the inner circumference of the (first or second) rotating component. Alternatively, the shaft receptacle can be designed through the opening of the (first or second) rotating component itself.

An optional device for bearing the shaft can also be provided.

In another advantageous embodiment, a further magnet is designed as a sensor magnet. For example, two magnets can also be provided here, which are arranged one behind the other in the axial direction, preferably on the shaft, wherein the second magnet is the sensor magnet. For example, the rotational speed can be measured using the magnetic properties of the holding device. As is well known, Hall sensory systems can be used.

The soft iron element or the magnet is particularly preferably pressed onto the shaft or the pinion. However, it is also conceivable to glue or spray them on or, in general, any form or force-fit connection known to the person skilled in the art.

It may particularly be provided that the soft iron element is formed from a soft magnetic material. The soft iron element is, for example, an iron core made of a soft magnetic material.

Particularly advantageously, a holding system can be provided which comprises a holding device as previously described and an electric drive, wherein the holding device is operatively connected to the electric drive.

The electric drive is preferably a DC motor, but in principle BLDC motors or any other form of drive known to the specialist are also conceivable. The motor vibration is dampened by using the holding device and prevented by an applied damping effect by the holding device during use. This has a positive effect on noise behavior, making quieter drives with a holding device possible. The holding device can provide the electric drive with an additional and significantly increased holding torque in order to advantageously hold a shaft in position and lock it.

The electric drive of the holding system can also preferably comprise a gearbox. Preferably, the shaft of the holding device corresponds to the drive shaft of the electric drive. This means that the holding device can exert a holding torque on the drive shaft and can be very easily installed together with the electric motor, for example within the housing of a roller blind drive.

In the static state described above, the electric drive does not exert any torque on the shaft. In the dynamic state also described above, the electric drive exerts a torque on the shaft.

The electric drive can be designed to be particularly tubular. The narrow, axially elongated shape of a tubular motor is used for a wide variety of drives such as roller blinds, venetian blinds and rolling gates, for example as a winding roller.

### BRIEF DESCRIPTION OF THE SEVERAL VIEWS OF THE DRAWINGS

The invention will now be described in more detail below with reference to the exemplary embodiments shown in the drawing. In the figures:

FIG. 1 shows an exploded view of a holding system in accordance with an exemplary embodiment;

FIG. 2 shows an exploded view of a holding system in accordance with a further exemplary embodiment;

FIG. 3 shows a detailed cross-sectional view from FIG. 1;

FIG. 4 shows a detailed cross-sectional view from FIG. 2;

FIG. 5 shows an exploded view of a holding system in accordance with a further exemplary embodiment; and

FIG. 6 shows an exploded view of a holding system in accordance with yet a further exemplary embodiment.

### DETAILED DESCRIPTION OF THE INVENTION

In describing preferred embodiments of the present invention illustrated in the drawings, specific terminology is employed for the sake of clarity. However, the invention is not intended to be limited to the specific terminology so selected, and it is to be understood that each specific element includes al technical equivalents that operate in a similar manner to accomplish a similar purpose.

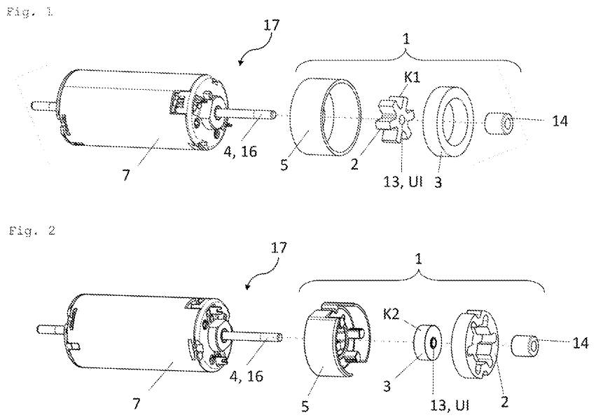

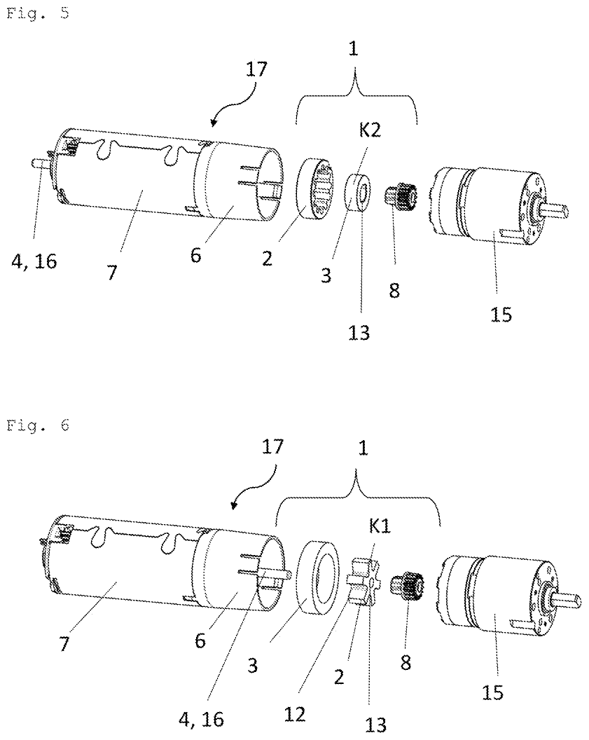

FIG. 1 shows an overview of a holding system 17 in accordance with an exemplary embodiment. The holding system 17 comprises a holding device 1 and an electric drive 7. The drive shaft 16 of the electric drive 7 may correspond to a shaft 4 comprised by the holding device 1. In other words, the holding device 1 and the electric drive 7 share a common shaft 4, 16, which in turn is connected to the application (e.g. a roller blind) via a gearbox 15 (FIGS. 5 and 6) (e.g. an electrically operated roller blind). By rotating the shaft 4, 16 via the electric drive 7, the connected application can be moved up or down. When the shaft is stopped by the electric drive 7, the shaft 4, 16 stops the rotational movement within a dynamic state and goes into a static state. Due to the holding force that the holding device 1 exerts on the shaft 4, a significantly increased holding torque is provided by the holding device 1. This allows the shaft 4 to be held and fixed in position, for example, and remain in this position for as long as required. This holding torque must first be overcome by the electric drive 7 when a user makes a corresponding input in order to set the shaft 4 in motion again. Furthermore, a gearbox is provided (represented in FIGS. 5 and 6), preferably at one end of the holding device 1. The electrical connection to a power supply is made via connecting wires (not shown here).

In the exemplary embodiment, the holding device 1 advantageously has the same outer diameter as the electric drive 7 including the end shield 5 that surrounds the components of the holding device 1. Integration in or as a tubular motor in a common housing is therefore advantageous. The holding device 1 provides the holding torque without causing increased noise and/or vibration of the components in the holding system 17. This also has the advantage of reducing wear.

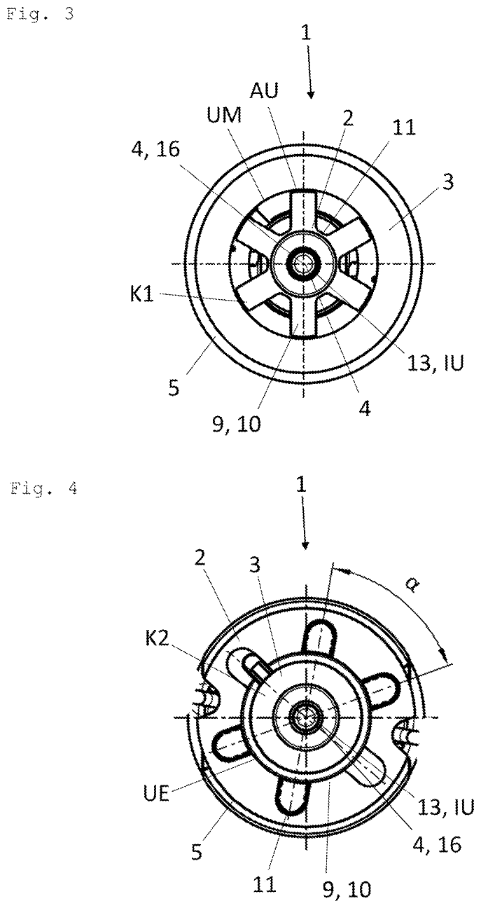

As can be seen in connection with the detailed representation of FIG. 3, the holding device 1 comprises a soft iron element 2 and a magnet 3, wherein in the exemplary embodiment the soft iron element 2 is arranged concentrically in the inner circumference UM of the magnet 3. The shaft 4 can be accommodated by a shaft receptacle in the soft iron element 2. The soft iron element 2 is firmly connected to the shaft 4, for example by pressing it on, and rotates with the moving shaft 4. The soft iron element 2 thus forms a first rotating component K1. The magnet 3 arranged around the soft iron element 2 is surrounded by the end shield 5 and is fixed in this exemplary embodiment. The soft iron element 2 forms several poles 10 with pole teeth 9 on its outer circumference AU. The soft iron element 2 has various pole tooth contours 11, angular in the example, but beveled or rounded shapes are also possible.

FIGS. 1 and 3 further show that, in addition to the magnet 3, a further magnet in the form of a sensor magnet 14 (alternatively a pulse disk for a magnetic or optical encoder, for example) is provided. In particular, the sensor magnet 14 is arranged axially downstream of the magnet 3, but preferably outside the soft iron element 2. A one-piece arrangement is also conceivable. Interaction with a Hall sensory system can be provided.

FIG. 2 shows an overview of a holding system 17 in accordance with a further exemplary embodiment. In this exemplary embodiment, the holding system 17 also comprises a holding device 1 and an electric drive 7. The drive shaft 16 of the electric drive may correspond to a shaft 4 comprised by the holding device 1. In other words, the holding device 1 and the electric drive 7 share a common shaft 4, 16, which in turn is connected to the application via a gearbox (for example an electrically operated roller blind). By rotating the shaft 4, 16 via the electric drive 7, the connected application (e.g. a roller blind) can be moved up or down. When the shaft is stopped by the electric drive 7, the shaft 4, 16 stops the rotational movement within a dynamic state and goes into a static state. Due to the holding force that the holding device 1 exerts on the shaft 4, a significantly increased holding torque is provided by the holding device 1. This allows the shaft 4 to be held and fixed in position, for example, and remain in this position for as long as required. This holding torque must first be overcome by the electric drive 7 when a user makes a corresponding input in order to set the shaft 4 in motion again. Furthermore, a gearbox 15 is provided (represented in FIGS. 5 and 6), preferably at one end of the holding device 1.

In this exemplary embodiment, the holding device 1 also advantageously has the same outer diameter as the electric drive 7, including an end shield 5 that surrounds the components of the holding device 1. Integration in or as a tubular motor in a common housing is therefore advantageous. The holding device 1 provides the holding torque without causing increased noise and/or vibration of the components in the holding system 17. This has the advantage of reducing wear.

As can be seen in connection with the detailed representation of FIG. 4, a soft iron element 2 and a magnet 3 are comprised by the holding device 1, wherein in the exemplary embodiment the magnet 3 is arranged (concentrically) within the inner circumference UE of the soft iron element. The shaft 4 is held in the magnet 3 by a shaft receptacle 13. The magnet 3 is firmly connected to the shaft 4, for example by pressing it on, and rotates with the moving shaft 4. The magnet 3 thus forms a second rotating component K2. The soft iron element 2 arranged around the magnet 3 is surrounded by the end shield 5 and is fixed in this exemplary embodiment. The soft iron element 2 forms several poles 10 with pole teeth 9 on its inner circumference UE. The soft iron element 2 has different pole tooth contours 11.

FIGS. 2 and 4 further show that, in addition to the magnet 3, a further magnet in the form of a sensor magnet 14 (alternatively a pulse disk for a magnetic or optical encoder, for example) is provided. In particular, the sensor magnet 14 is arranged axially downstream of the magnet 3, but preferably outside the magnet 3 or soft iron element 2. A one-piece arrangement is also conceivable. Interaction with a Hall sensory system can be provided.

FIG. 4 further shows that the soft iron element 2 with different pole teeth 9 of the poles 10 of the soft iron element 2 arranged depending on the intended angle α. The pole teeth 9 are arranged at an angle α of preferably 10° to 60°, particularly between 20° to 30°, especially preferably 30°, all around. Angles α in the area of 1° to 90° are also conceivable. In the example shown, the respective pole tooth contour 11 is round to oval, but can also be angular, triangular or similar.

Even though the invention has been explained several times using the example of an electrically operated roller blind, it is not limited to such systems. Rather, the holding device or holding system according to the invention can also be used in many other technical areas that are operatively connected to an (electric) drive. It is also possible to use the holding device as a brake or as a clutch. In principle, the holding device can be used with existing electric drives, so a holding device can be retrofitted. The invention is not limited to a geared motor, nor to the application of a drive for roller blinds. Rather, this application is to be understood as an example to illustrate the invention of the person skilled in the art. In principle, such a system can be attached to any motor and geared motor with adapted dimensions and magnet materials and can be used in any application that requires an increased holding torque in the static state.

FIG. 5 shows a holding device 1 with a soft iron element 2 and a magnet 3, which are arranged concentrically to one another, wherein the magnet 3 in operative connection with the soft iron element 2 exerts a holding torque on the shaft 4 in a static state. The magnet 3 is arranged on or at the pinion 8, which is fastened to the shaft 4. The magnet 3 is arranged on the inner circumference of the soft iron element UE and forms a second rotating component K2. The holding device 1 is in connection with the end shield 6 of the electric drive 7. The soft iron element 2 has a plurality of pole teeth 9 on its inner circumference UE. A shaft receptacle 13 is provided on the inner circumference IU of the rotating components K1, K2. The electric drive 7 comprises a gearbox 15.

FIG. 6 shows a holding device 1 with a soft iron element 2 and a magnet 3, which are arranged concentrically to one another, wherein the magnet 3 in operative connection with the soft iron element 2 exerts a holding torque on a shaft 4 in a static state. The soft iron element 2 is arranged on or at the pinion 8, which is fastened to the shaft 4. The soft iron element 2 is arranged on the inner circumference UM of the magnet 3 and forms a first rotating component K1. The holding device 1 is in connection with the end shield 6 of the electric drive 7 . The soft iron element 2 has a plurality of pole teeth 9 on its outer circumference AU. The pole teeth 9 have bevels 12 on their outer circumference. A shaft receptacle 13 is provided on the inner circumference IU of the rotating components K1, K2. The electric drive 7 comprises a gearbox 15.

Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

### LIST OF REFERENCE SYMBOLS

1 Holding device
2 Soft iron element
3 Magnet
4 Shaft
5 End shield
6 End shield
7 Electric drive
8 Pinion
9 Pole teeth
10 Poles
11 Pole tooth contour
12 Bevel
13 Shaft receptacle
14 Sensor magnet
15 Gearbox
16 Drive shaft
17 Holding system
K1 First rotating component
K2 Second rotating component
UM Inner circumference of the magnet
UE Inner circumference of the soft iron element
IU Inner circumference of the rotating components
AU Outer circumference of the soft iron element

What is claimed is:

1. A holding device associated with an electric drive having an end shield, the holding device comprising a soft iron element with an inner circumference and a magnet, the soft iron element and the magnet being arranged concentrically to one another, wherein the magnet, in operative connection with the soft iron element, exerts a holding torque on a shaft in a static state, wherein the magnet is arranged on the shaft, on the inner circumference of the soft iron element, and forms a second rotating component, and wherein the holding device is in connection with the end shield of the electric drive.

2. A holding device associated with an electric drive having an end shield, the holding device comprising a soft iron element and a magnet with an inner surface, the soft iron element and the magnet being arranged concentrically to one another, wherein the magnet, in operative connection with the soft iron element, exerts a holding torque on a shaft in a static state, wherein the soft iron element is arranged on the shaft, on the inner circumference of the magnet, and forms a first rotating component, and wherein the holding device is in connection with the end shield of the electric drive.

3. The holding device according to claim 1, wherein the holding device is operatively connected to a pinion which is provided on the shaft and is covered by the end shield.

4. The holding device according to claim 1, wherein the soft iron element further comprises an outer surface and has a plurality of pole teeth in its inner circumference or on its outer circumference.

5. The holding device according to claim 4, wherein the plurality of pole teeth of the soft iron element are matched relative to the number of poles of the magnet.

6. The holding device according to claim 4, wherein the pole teeth are preferably arranged at the same angle α to one another and/or have a pole tooth contour.

7. The holding device according to claim 4, wherein the pole teeth have bevels on their outer circumference.

8. The holding device according to claim 1, wherein the holding torque is adjusted via the axial length and/or the material selection and/or via an air gap and/or an axial overlap of the rotating component.

9. The holding device according claim 1, wherein a shaft receptacle is provided in the inner circumference of the rotating component.

10. The holding device according claim 1, further comprising a second magnet designed as a sensor magnet.

11. The holding device according claim 3, wherein the soft iron element or the magnet is pressed onto the shaft or the pinion.

12. The holding device according to claim 1, wherein the soft iron element is formed of a soft magnetic material.

13. A holding system comprising a holding device according to claim 1 and an electric drive, wherein the holding device is operatively connected to the electric drive.

14. The holding system according to claim 13, wherein the electric drive comprises a gearbox.

15. The holding system according to claim 13, wherein the shaft of the holding device corresponds to a drive shaft of the electric drive.

16. The holding device according to claim 2, wherein the soft iron element further comprises an outer surface and has a plurality of pole teeth in its inner circumference or on its outer circumference.

17. The holding device according to claim 16, wherein the plurality of pole teeth of the soft iron element are matched relative to the number of poles of the magnet.

18. The holding device according to claim 2, wherein the holding torque is adjusted via the axial length and/or the material selection and/or via an air gap and/or an axial overlap of the rotating component.

19. The holding device according claim 2, wherein a shaft receptacle is provided in the inner circumference of the rotating component.

20. The holding device according claim 2, further comprising a second magnet designed as a sensor magnet.
